(19) United States
(12) Patent Application Publication
(10) Pub. No.: US 2023/0385708 A1
(43) Pub. Date: Nov. 30, 2023

(54) RECONCILING COMPUTING INFRASTRUCTURE AND DATA IN FEDERATED LEARNING

(71) Applicant: Cisco Technology, Inc., San Jose, CA (US)

(72) Inventors: Myungjin Lee, Bellevue, WA (US); Gaoxiang Luo, Minneapolis, MN (US); Ramana Rao V. R. Kompella, Cupertino, CA (US)

(21) Appl. No.: 17/828,582

(22) Filed: May 31, 2022

(51) Int. Cl. G06N 20/20; G06F 16/901

(52) U.S. Cl. CPC G06N 20/20; G06F 16/9027

(57) ABSTRACT

In one embodiment, a controller for a federated learning system represents computing infrastructure for the federated learning system as a tree structure. The controller forms associations between datasets available to the federated learning system and nodes in the tree structure. The controller receives one or more instructions to perform model training in the federated learning system with datasets specified using their associations. The controller configures, in response to the one or more instructions, the federated learning system to perform the model training using the datasets specified by the one or more instructions using the tree structure.

### TECHNICAL FIELD

The present disclosure relates generally to computer networks, and, more particularly, to reconciling computing infrastructure and data in federated learning.

### BACKGROUND

Machine learning is becoming increasingly ubiquitous in the field of computing. Indeed, machine learning is now used across a wide variety of use cases, from analyzing sensor data from sensor systems to performing future predictions for controlled systems. As machine learning techniques continue to mature, it is expected that the uses for machine learning will continue to grow.

The performance of a machine learning model is largely dependent on the quality of the data on which the model is trained. Complicating the collection of ‘good’ training data, though, are data privacy policies and regulations that place restrictions on the sharing of data that could be used to train a machine learning model. Federated learning presents a potential solution to these challenges, as it allows for training to be performed on-site, negating the need to export the data for model training.

Thus, to implement federated learning, learning tasks are deployed to compute nodes located at the various sites at which training is to be performed. Today, this is a largely manual process that is prone to errors and very difficult to scale. In a simple case, a learning task is configured on a compute node that also stores the training data used for the task. However, this is often not the case and the training data also needs to be moved to the on-site compute node, which also needs to be performed manually.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates an example template for a machine learning workload;

FIG. 4 illustrates an example of a machine learning workload defined in accordance with the template of FIG. 3;

FIG. 5 illustrates an example of an infrastructure registry storing information regarding the computing infrastructure of a federated learning system;

FIG. 6 illustrates an example of a metadata database associating available datasets with the tree structure of FIG. 5;

FIGS. 7A-7B illustrate example instructions to perform model training in the federated learning system;

FIG. 8 illustrates an example of training results being aggregated in a federated learning system; and

FIG. 9 illustrates an example simplified procedure for reconciling computing infrastructure and data in federated learning.

### DESCRIPTION OF EXAMPLE EMBODIMENTS

### Overview

According to one or more embodiments of the disclosure, a controller for a federated learning system represents computing infrastructure for the federated learning system as a tree structure. The controller forms associations between datasets available to the federated learning system and nodes in the tree structure. The controller receives one or more instructions to perform model training in the federated learning system with datasets specified using their associations. The controller configures, in response to the one or more instructions, the federated learning system to perform the model training using the datasets specified by the one or more instructions using the tree structure.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

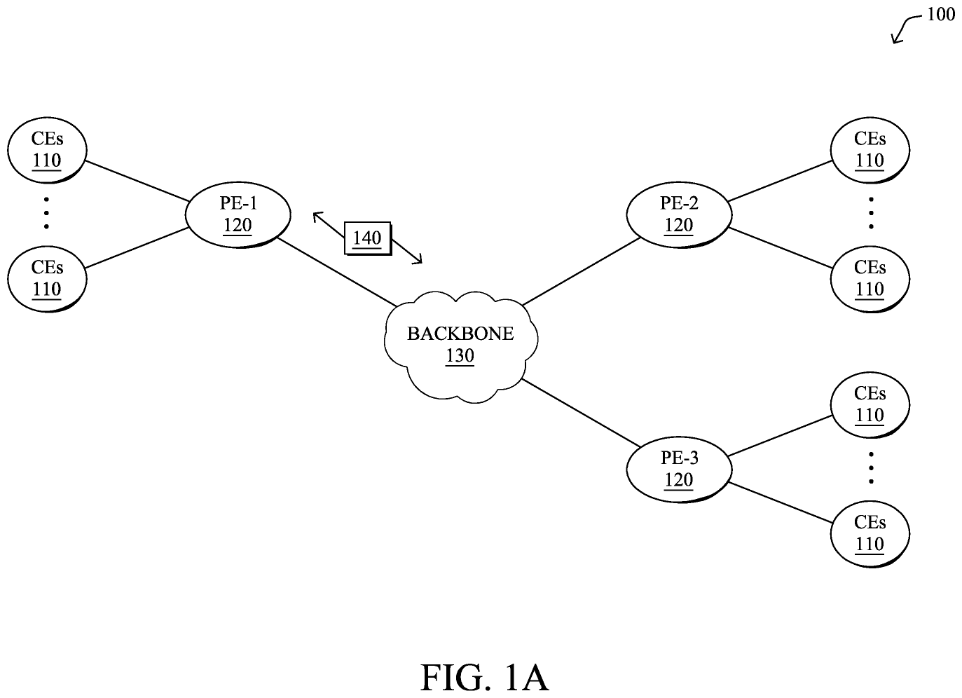

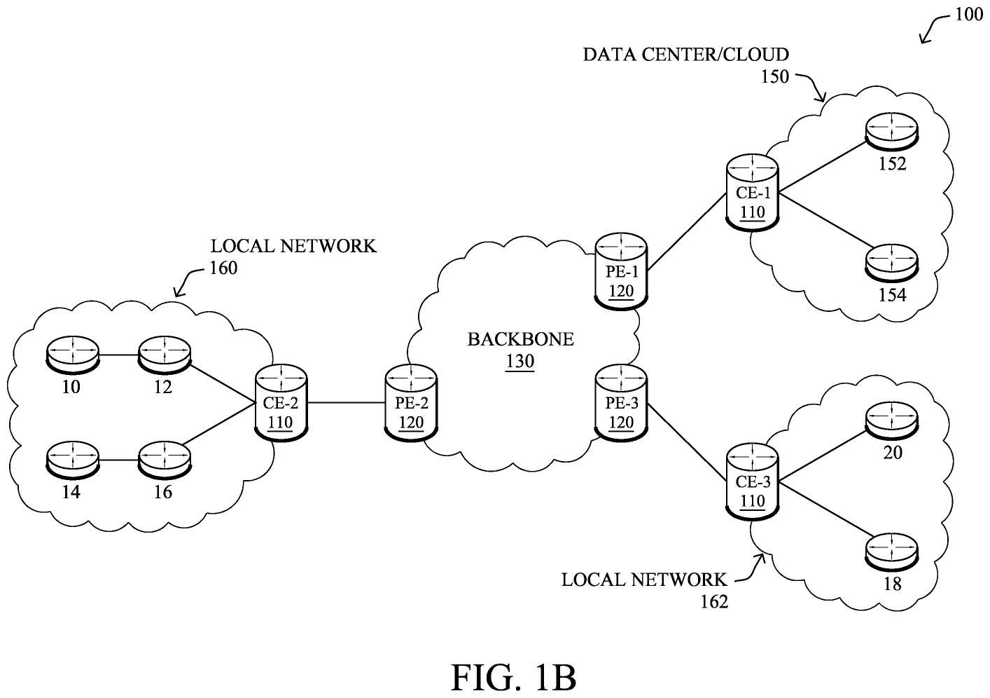

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection).
Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

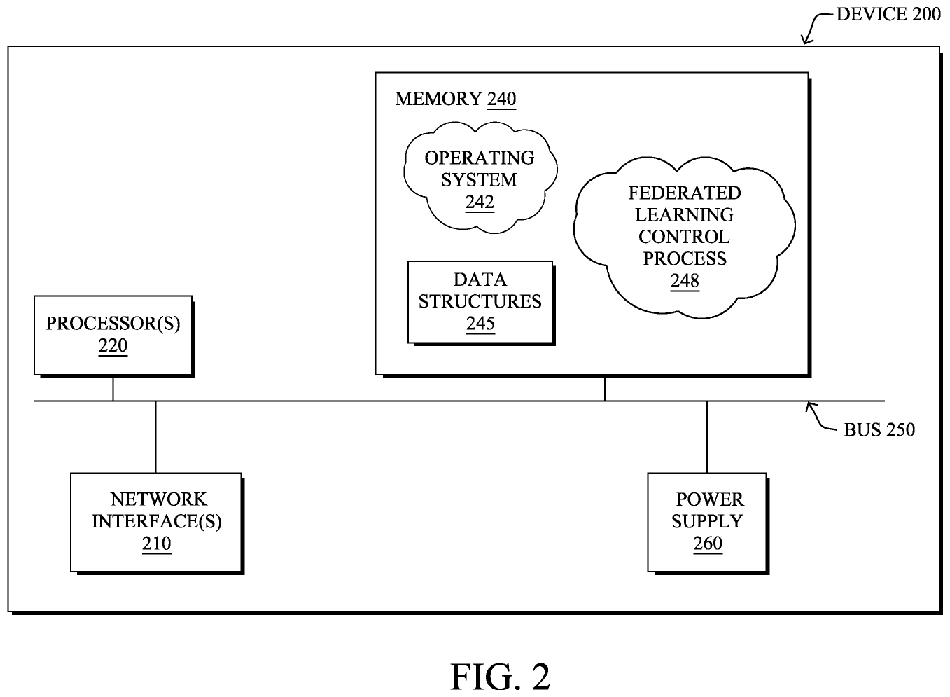

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise federated learning control process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In various embodiments, as detailed further below, federated learning control process 248 may also include computer executable instructions that, when executed by processor(s) 220, cause device 200 to perform the techniques described herein. To do so, in some embodiments, federated learning control process 248 may utilize machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, federated learning control process 248 may employ, or be responsible for the deployment of, one or more supervised, unsupervised, or semi-supervised machine learning models. Generally, supervised learning entails the use of a training set of data, as noted above, that is used to train the model to apply labels to the input data. For example, the training data may include sample image data that has been labeled as depicting a particular condition or object. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that federated learning control process 248 can employ, or be responsible for deploying, may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

Unfortunately, running a machine learning workload is a complex and cumbersome task, today. This is because expressing a machine learning workload is not only tightly coupled with infrastructure resource management, but also embedded into the machine learning library that supports the workload. Consequently, users responsible for machine learning workloads are often faced with time-consuming source code updates and error-prone configuration updates in an ad-hoc fashion for different types of machine learning workloads, which may be used to perform tasks such as aggregated model training, performing inferences on a certain dataset, or the like. However, defining a machine learning workload, especially across a distributed set of nodes/sites, can also be a very cumbersome and error-prone task.

To simplify the definition of a workload, the techniques herein propose decomposing machine learning workloads into primitives/building blocks and decoupling core building blocks (e.g., the AI/ML algorithm) of the workload from the infrastructure building blocks (e.g., network connectivity and communication topology). The infrastructure building blocks are abstracted so that the users can compose their workloads in a simple and declarative manner. In addition, scheduling the workloads is straightforward and foolproof, using the techniques herein.

In various embodiments, the techniques herein propose representing a machine learning workload using the following building block types:
Role—this is logical unit that defines behaviors of a component. Hence, role contains a software piece. Role allows an artificial intelligence (AI)/machine learning (ML) engineer to focus on behaviors of a component associated with a role. At runtime, a role may consist of one or more instances, but the engineer only needs to work on one role at a time during the workload design phase without the need to understand any runtime dependencies or constraints.
Channel—this is a logical unit that abstracts the lower-layer communication mechanisms. In some embodiments, a channel provides a set of application programming interfaces (APIs) that allow one role to communicate with another role. Some of key APIs are ends( ), broadcast( ), send( ), and recv( ). Function ends( ) returns a set of nodes attached to the other end of a given channel. With this function, a node on one side of the channel can choose other nodes at the other end of the channel and subsequently call send( ) and recv( ) to send or receive data with each node. A channel eliminates any source code changes, even when the underlying communication mechanisms change.

Roles and channels may also have various properties associated with them, to control the provisioning of a machine learning workload. In some embodiments, these properties may be categorized as predefined ones and extended ones. Predefined properties may be essential to support the provisioning and set by default, whereas extended properties may be user-defined. In other words, to enrich the functionality of the roles and channels, the user engineer may opt to customize extended properties.

By way of example, a role may have either or both of the following pre-defined properties:
Replica—this properly controls the number of role instances per channel. By default, this may be set to one, meaning there is one role instance per channel. However, a user may elect to set this property to a higher value, as desired.
Load Balance—this property provides the ability to load balance demands given to the role instances and to do fail-overs.

For a channel, there may be the following property:
Group By—this property accepts a list of values so that communication between roles in a channel are controlled by using the specified values. For example, this property can be used to control the communication boundary, such as allowing communications only in a specified geographic area in this property (e.g., U.S., Europe, etc.).

Using the above building blocks and properties, the system can greatly simplify the process for defining a machine learning workload for a user.

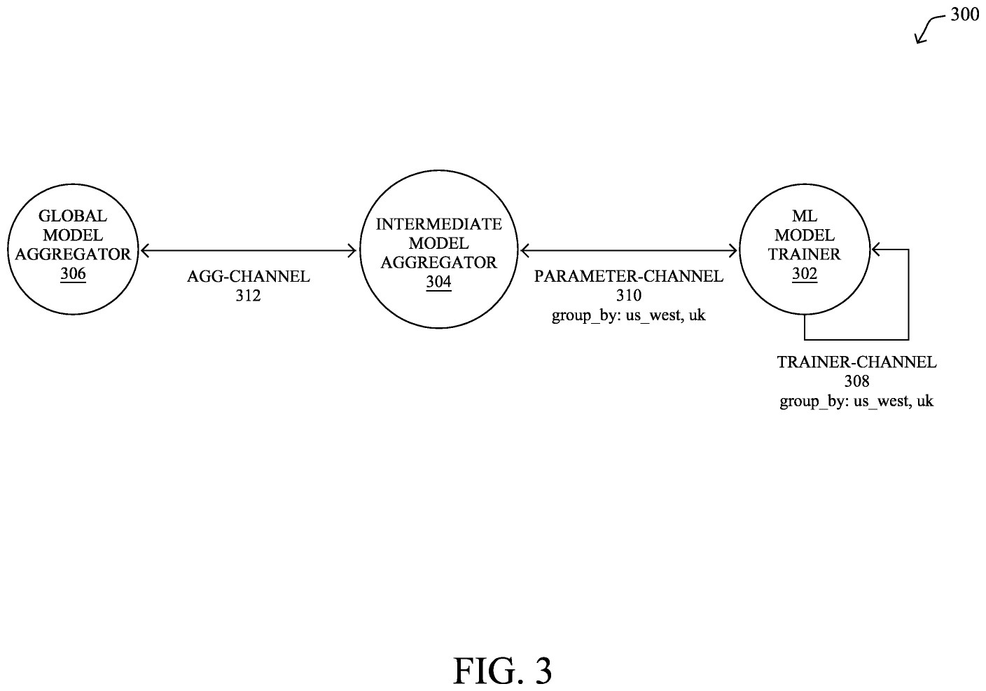

FIG. 3 illustrates an example template 300 for a machine learning workload, according to various embodiments. As shown, assume that a user wants to define a machine learning workload to train a machine learning model using data stored at different geographic locations. In a simple implementation, each site could simply transfer their respective datasets to a central location at which a model may be trained on that data. However, there are many instances in which the data is private, thereby preventing it from being sent off-site. For example, the datasets may include personally identifiable information (PII) data, medical data, financial data, or the like, that cannot leave their respective sites.

As shown, workload design template 300 consists of three roles: machine learning (ML) model trainer 302, intermediate model aggregator 304, and global model aggregator 306. Connecting them in template 300 may be three types of channels: trainer channel 308, parameter channel 310, and aggregation channel 312.

Trainer channels allows communication between peer trainer nodes at runtime. For instance, assume that the group by property is set to group trainer nodes into separate groups located in the western U.S. and the UK. In such a case, trainer channels may be provisioned between these nodes. Similarly, a parameter channel may enable communications between intermediate model aggregators, such as intermediate model aggregator 304 and trainer nodes in the various groups, such as model trainer 302. Finally, an aggregation channel may connect the intermediate model aggregator to global model aggregator 306.

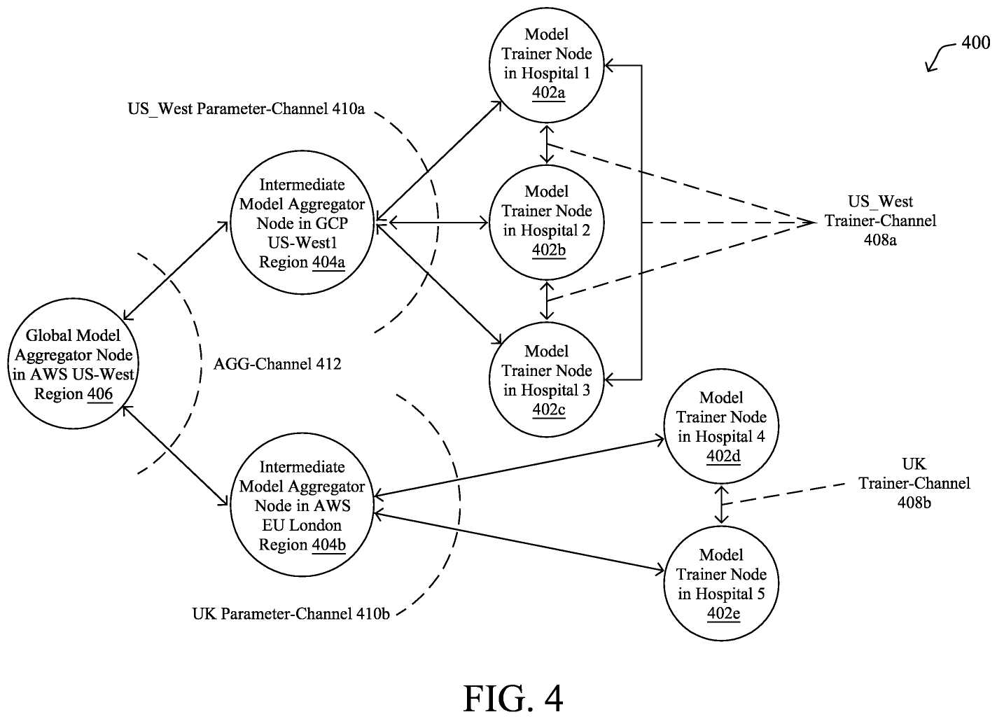

FIG. 4 illustrates an example of a machine learning workload 400 defined in accordance with the template of FIG. 3, according to various embodiments. As shown, assume that the goal of the machine learning workload is to train a machine learning model to detect certain features (e.g., tumors, etc.) within a certain type of medical data (e.g., X-rays, MRI images, etc.). Such medical data may be stored at different hospitals or other locations across different geographic locations. For instance, assume that the medical data is spread across different hospitals located in the UK and the western US, each of which maintains its own training dataset.

To provision the machine learning workload across the different hospitals, a user may convey, via a user interface, definition data for the workload. For instance, the user may specify the type of model to be trained, values for the replica property, the number of datasets to use, tags for the group by property, any values for the load balancing property, combinations thereof, or the like.

Based on the definition data, the system may identify that the needed training datasets are located at nodes 402a-402e (e.g., the different hospitals). Note that the user does not need to know where the data is located during the design phase for machine learning workload 400, as the system may automatically identify nodes 402a-402e, automatically, using an index of their available data. In turn, the system may designate each of nodes 402a-402e as having training roles, meaning that each one is to train a machine learning model in accordance with the definition data and using its own local training dataset. In other words, once the system has identified nodes 402a-402e as each having training datasets matching the requisite type of data for the training, the system may provision and configure each of these nodes with a trainer role.

Assume now that the group by property has been set to group nodes 402a-402e by their geographic locations. Consequently, nodes 402a-402c may be grouped into a first group of trainer/training nodes, based on these hospitals all being located in the western US, by being tagged with a “us_west” tag. Similarly, nodes 402d-402e may be grouped into a second group of training nodes, based on these hospitals being located in the UK, by being tagged with a “uk tag.

For purposes of simplifying this example, also assume that the replica property is set to 1, by default, meaning that there is only one trainer role instance to be configured at each of nodes 402a-402e.

To connect the different sites/nodes 402a-402e in each group, the system may also provision and configure trainer channels between the nodes in each group. For instance, the system may configure trainer channels 408a between nodes 402a-402c within the first geographic group of nodes, as well as a trainer channel 408b between nodes 402d-402e in the second geographic group of nodes.

Once the system has identified nodes 402a-402e, it may also identify intermediate model aggregator nodes 404a-404b, to support the groups of nodes 402a-402c and 402d-402e, respectively. In turn, the system may configure model aggregator nodes 404a-404b with intermediate model aggregation roles. In addition, the system may configure parameter channels 410a-410b to connect the groups of nodes 402a-402c and 402d-402e with intermediate model aggregator nodes 404a-404b, respectively. These parameter channels 410a-410b, like their respective groups of nodes 402, may be tagged with the ‘us_west’ and ‘uk’ tags, respectively. In some instances, intermediate model aggregator nodes 404a-404b may be selected based on their distances or proximities to their assigned nodes among nodes 402a-402e. For instance, intermediate model aggregator node 404b may be cloud-based and selected based on it being in the same geographic region as nodes 402d-402e, Indeed, intermediate model aggregator node 404a may be provisioned in the Google cloud (gcp) in the western US, while intermediate model aggregator node 404b may be provisioned in the Amazon cloud (AWS) in the UK region.

During execution, each trainer node 402a-402e may train a machine learning model using its own local training dataset. In turn, nodes 402a-402e may send the parameters of these trained models to their respective intermediate model aggregator nodes 404a-404b via parameter channels 410a-410b. Using these parameters, each of intermediate model aggregator nodes 404a-404b may form an aggregate machine learning model. More specifically, intermediate model aggregator node 404a may aggregate the models trained by nodes 402a-402c into a first intermediate model and intermediate model aggregator node 404h may aggregate the models trained by nodes 402d-402e into a second aggregate model.

Finally, the system may also provision machine learning workload 400 in part by selecting and configuring global model aggregator node 406. Here, the system may configure a global aggregation role to global model aggregator node 406 and configure aggregation channels 412 that connect it to intermediate model aggregator nodes 404a-404b. Note that these aggregation channels may not be tagged with a geographic tag, either.

Once configured and provisioned, intermediate model aggregator nodes 404a-404b may send the parameters for their respective intermediate models to global model aggregator node 406 via aggregation channels 412. In turn, global model aggregator node 406 may use these model parameters to form a global, aggregated machine learning model that can then be distributed for execution. As a result of the provisioning by the system, the resulting global model will be based on the disparate training datasets across nodes 402a-402e, and in a way that greatly simplifies the definition process of the machine learning workload used to train the model.

As noted above, configuring a learning node in a federated learning system to perform model training using a particular dataset is a largely manual process that is prone to errors and very difficult to scale. In a simple case, a learning task is configured on a compute node that also stores the training data used for the task. However, this is often not the case and the training data also needs to be moved to the on-site compute node, which also needs to be performed manually.

### Reconciling Computing Infrastructure and Data in Federated Learning

The techniques introduced herein allow for the storage of information about the various datasets and computing infrastructures available in a federated learning deployment. In some aspects, this is done in a hierarchical manner (e.g., using a tree structure) that also integrates location information, allowing for the automated provisioning of federated learning tasks in a manner that complies with the various data sovereignty and privacy rules applicable to the available datasets.

Illustratively, the techniques described herein may be performed by hardware, software, and/or firmware, such as in accordance with federated learning control process 248, which may include computer executable instructions executed by the processor 220 (or independent processor of interfaces 210) to perform functions relating to the techniques described herein.

Specifically, according to various embodiments, a controller for a federated learning system represents computing infrastructure for the federated learning system as a tree structure. The controller forms associations between datasets available to the is federated learning system and nodes in the tree structure. The controller receives one or more instructions to perform model training in the federated learning system with datasets specified using their associations. The controller configures, in response to the one or more instructions, the federated learning system to perform the model training using the datasets specified by the one or more instructions using the tree structure.

Operationally, the techniques herein propose a systematic way of reconciling computing infrastructure and available datasets in a federated learning system. In various embodiments, the techniques herein propose two primary components: 1.) an infrastructure registry that stores information about the computing infrastructure of the federated learning system that could be leveraged to perform a learning task and 2.) a metadata database that stores information about the various datasets available to the federated learning system.

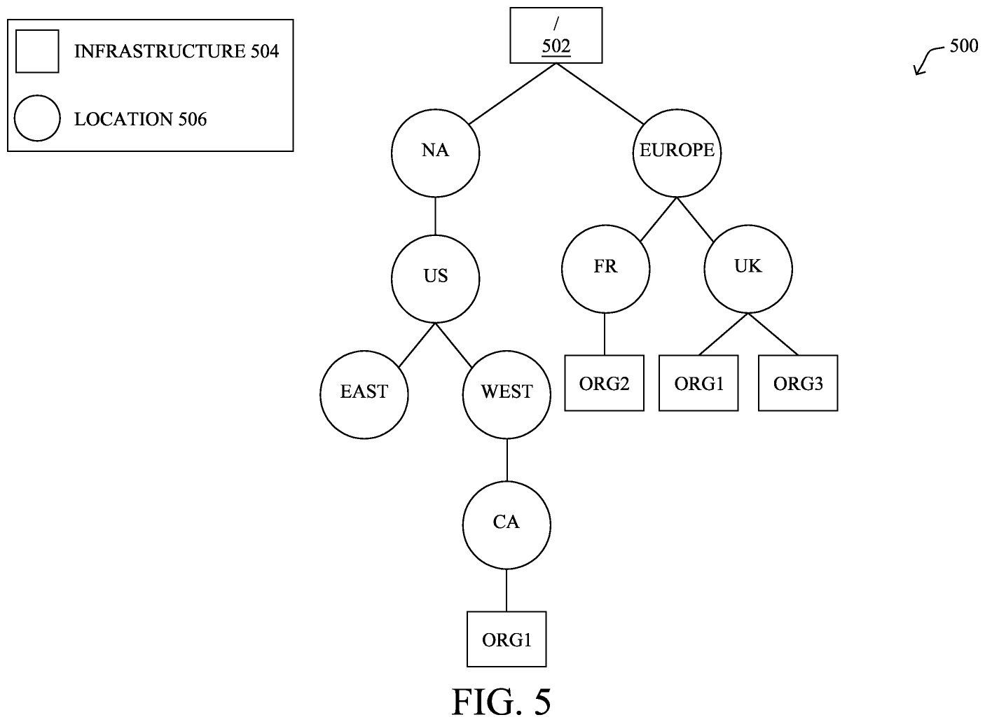

FIG. 5 illustrates an example of an infrastructure registry 500 storing information regarding the computing infrastructure of a federated learning system. In various embodiments, infrastructure registry may leverage a tree structure that has been formed to represent the computing infrastructure of the federated learning system. Such a registry may be accessed by a controller for the federated learning system (e.g., a device 200) to perform its supervisory control over the system.

As shown, the tree structure may include any or all of the following types of nodes that are interconnected with one another:
1. A root node 502—This node represents the highest point of the hierarchy in the infrastructure registry whereby all other nodes in the tree structure are subordinate to this node. Preferably, the tree structure has a single root node 502, in one embodiment.
2. Infrastructure nodes 504—Nodes of this type are used to represent the specific computing infrastructure at which tasks/workloads may be executed within the federated learning system. In various s embodiments, an infrastructure node 504 may represent a specific device or, alternatively, a collection of devices having shared properties, such as being operated by the same organization.
3. Location nodes 506—Nodes of this type are used to represent the geographic locations at which the various computing infrastructure of the federated learning system are located.

By representing the computing infrastructure in infrastructure registry 500 using a tree structure, this allows for the relationships between the computing infrastructure to be stored and represented, as well. For example, as shown in FIG. 5, assume that there are three organizations that participate in the federated learning system: org1, org2, and org3. In such a case, the infrastructure under the control of each of these organizations may be represented as infrastructure nodes 504 under various location nodes 506 that represent their physical locations. Here, different layers of location node 506 in the hierarchy may also correspond to different degrees of granularity with respect to the locations (e.g., cities, states, countries, continents, etc.). For instance, org2 may be located in France which is, in turn, located in Europe.

In various embodiments, portions of the tree structure store in infrastructure registry 500 can be referenced in a manner similar to a file system. For instance, root node 502 may be represented by the character ‘/.’ Similarly, the path “/europe/uk/org3” may be used to reference the infrastructure of org3 located in the U.K. in Europe.

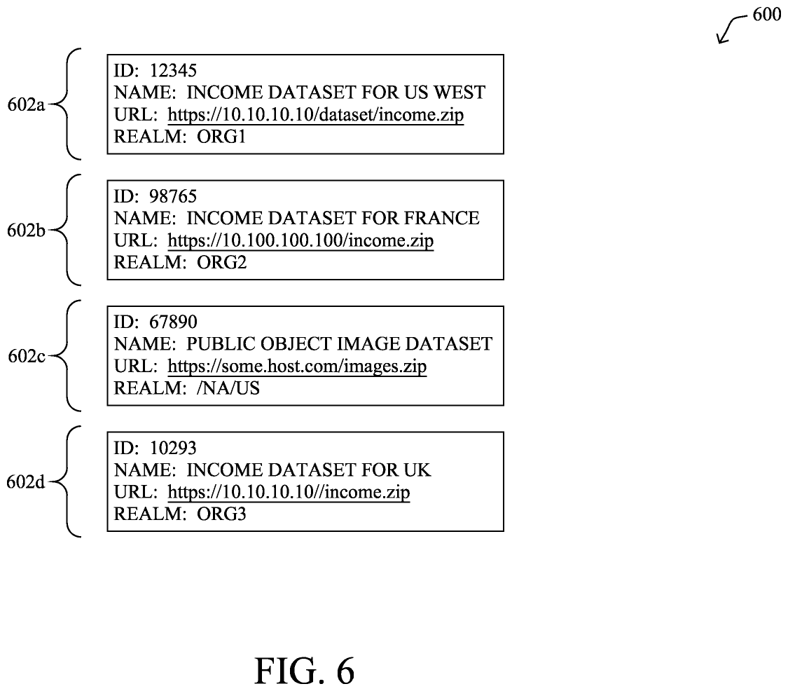

FIG. 6 illustrates an example of a metadata database 600 associating available datasets with the tree structure of FIG. 5, according to various embodiments. In general, the purpose of metadata database 600 is to store metadata that represents the different datasets that could be used by the federated learning system, such as for purposes of model training. It should also be noted that metadata database 600 may only store metadata about the datasets, not the actual datasets, which are stored in the infrastructures of their respective organizations.

For example, metadata database 600 may comprise any number of entries 602, such as entries 602a-602d shown, each of which represents a different dataset. In some embodiments, each dataset may have a unique identifier stored in its respective entry 602 in metadata database 600. In addition, each entry 602 may store the URL or other address of the dataset, a name for the dataset, or other such information.

According to various embodiments, another concept introduced herein is referred to as a ‘realm,’ which may also be stored in a given entry 602 in metadata database 600 and represents the boundary for access to the corresponding dataset. In various embodiments, such a realm may take the form of an association to a point in the tree structure in infrastructure registry 500. For instance, the format of a realm may be: [<infrastructure ID>|<location path>], meaning that either an infrastructure ID (e.g., an identifier for an infrastructure node in the tree structure) or a location path (e.g., a branch in the tree structure) may be used to define the access boundary.

For instance, consider a dataset whose unique identifier is 12345 and is represented in metadata database 600 by entry 602a. The dataset has a realm specified as “org1,” which is an infrastructure ID. On the other hand, in entry 602b, the realm of the dataset having a unique identifier of 67890 is set to “/na/us,” which represents a location is path.

In case of entry 602a, the dataset is only accessible and processed within the computing infrastructure of org1. Usually, any access to an internal infrastructure and resources (e.g., data) in it is strictly controlled, such as via security policies and firewall rules. Hence, a dataset owner is only responsible for ensuring that dataset is accessible within the internal infrastructure.

In contrast, in entry 602c, because the realm of the dataset is a location path (i.e., “/na/us”), and not tied to a specific organization's infrastructure, the dataset may be a public one and can be accessed by any device in any infrastructure (e.g., public cloud) within the specified location path. Unlike private datasets whose realm is an infrastructure ID, enforcing this type of realm is weak, meaning that the system abides by the realm set by the location path (e.g., united states in this case), but it is still possible for the dataset to be accessed outside the U.S., since it has a public URL. In addition, the root (e.g., represented as simply “I”) may be specified as the realm for any public datasets that are globally accessible.

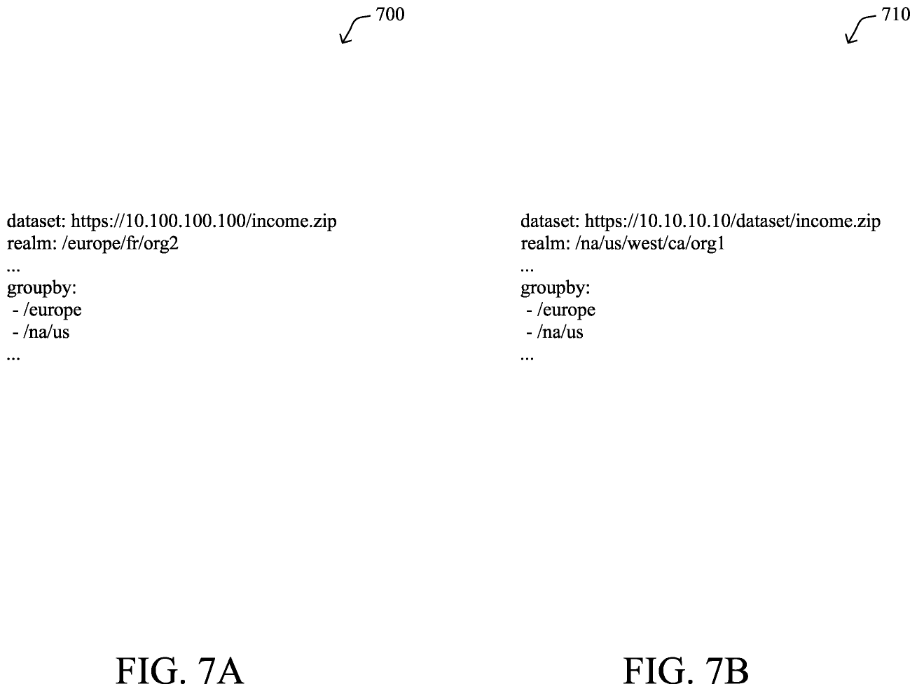

In various embodiments, the associations between the tree structure in infrastructure registry 500 and the various datasets represented in metadata database 600 allows for instructions for the federated learning system to be specified in a simplified manner. For example, FIGS. 7A-7B illustrate example instructions to perform model training in the federated learning system, in some embodiments.

As shown in FIG. 7A, a groupby instruction may be specified for a particular dataset (e.g., the dataset having entry 602b in FIG. 6), such as via a command line instruction, part of a configuration file, or the like. In general, a groupby instruction is a primitive that can be specified for the datasets to be used in the federated learning system for model training and may include a list of location paths (or infrastructure IDs), such as based on the realm values for the respective datasets. Here, the configuration 700 may include an instruction to use the specified dataset for training, as well as a a groupby is instruction that indicates that model training results that are based on the dataset having entry 602b in FIG. 6 should be aggregated at two different locations: Europe and the U.S. Similarly, configuration 710 in FIG. 7B may include a groupby instruction that the training results for the dataset represented by entry 602a in FIG. 6 should also be aggregated in Europe and in the U.S.

In turn, the controller may configure the respective infrastructure of the federated learning system to perform the model training. Here, since the groupby instruction value, “/europe” contains the realm “/europe/fr/org2,” the trainer using this configuration will be grouped by the label “/europe.” Similarly, the groupby value “/na/us” contains the realm “/na/us/west/ca/org1,” so the corresponding trainer will be grouped by the label “/na/us.”

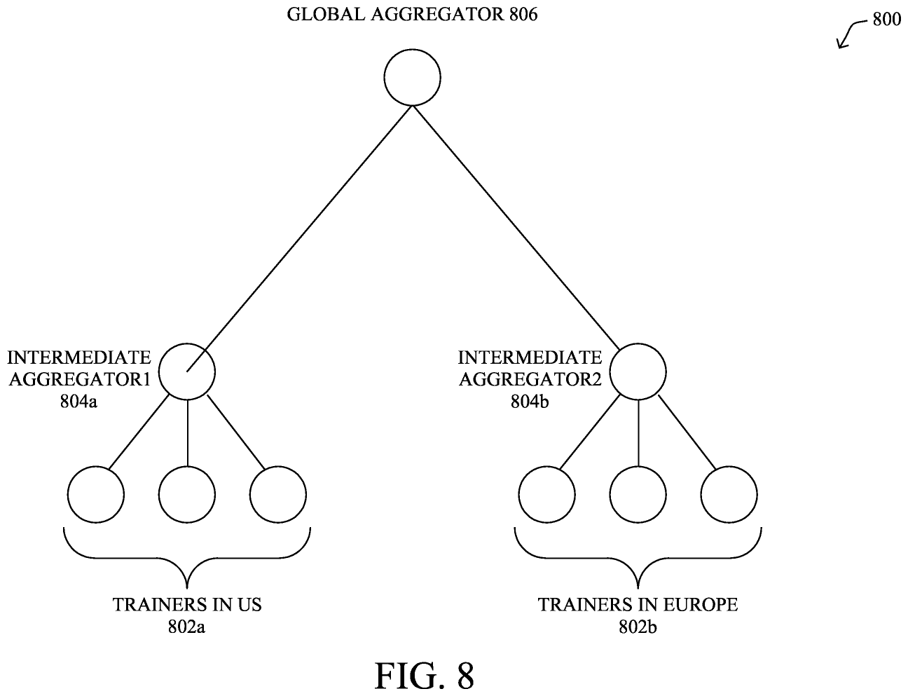

FIG. 8 illustrates an example of training results being aggregated in a federated learning system, according to various embodiments. Continuing the examples of FIGS. 7A-7B, assume now that the controller has configured the federated learning system based on the configuration files 700-710 and the instructions therein. In such a case, training workloads may be provisioned to two different sets of trainers/training nodes: trainers 802a in the U.S. and trainers 802b in Europe. Based on the groupby instructions, the controller may also configure intermediate aggregators 804a-804b, with intermediate aggregator 804a aggregating the training results from trainers 802a and intermediate aggregator 804b aggregating the training results from trainers 802b. In addition, a global aggregator 806 may also be configured to aggregate the results from intermediate aggregators 804a-804b.

Note previously in FIG. 5 that the ‘org1’ infrastructure is registered to more than one location: “/na/us/west/ca/org1” and “/europe/uk/org1.” Thus, in some embodiments, the realm expansion to a full path can also be ambiguous. For instance, for dataset of ID 12345, there are two possible realm expansions: /na/us/west/ca/org1 and /europe/uk/org1. But, with the help of groupby values, which are specified prior to runtime of the model training, the controller may automatically select a realm that matches the groupby values. When no groupby value is set, a global group (i.e., “/”) may be assumed and the controller may choose one of any possible realm expansions. By allowing multiple registrations of the same infrastructure, this allows for different groupings. For instance, the user may decide to group trainers with “/europe/fr” and “/europe/uk” groupby values. Then, trainers for dataset of IDs 12345 and 10293 are grouped together and trainer for dataset of ID 98765 is grouped by “/europe/fr.” Hence, this methodology ensures flexibility.

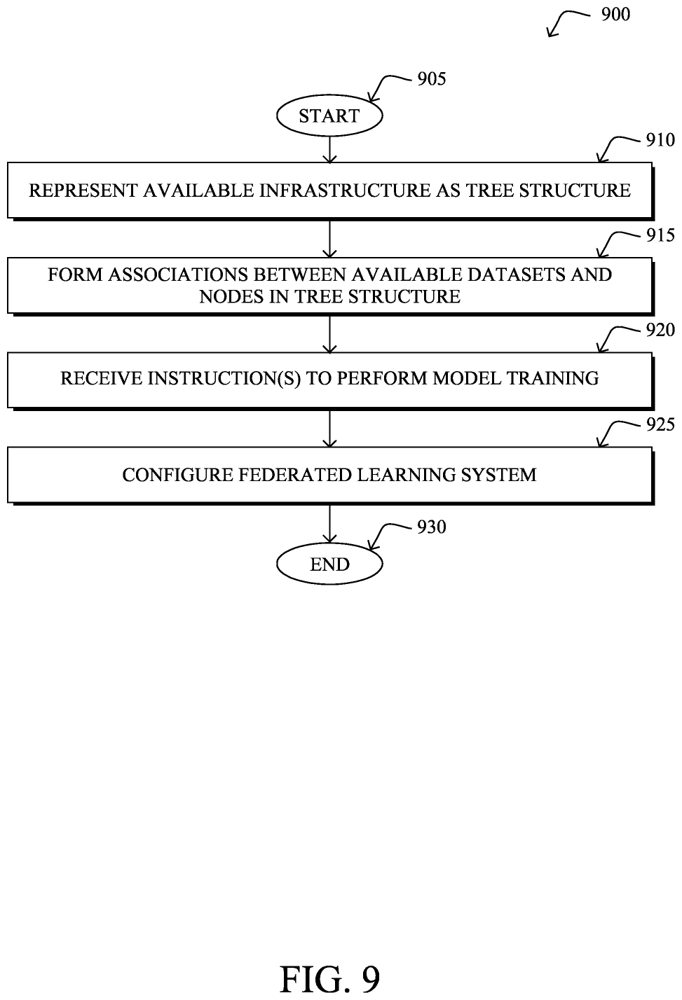

FIG. 9 illustrates an example simplified procedure 900 (e.g., a method) for reconciling computing infrastructure and data in federated learning, in accordance with one or more embodiments described herein. For example, a non-generic, specifically configured controller for a federated learning system (e.g., device 200), may perform procedure 900 by executing stored instructions (e.g., federated learning control process 248). The procedure 900 may start at step 905, and continues to step 910, where, as described in greater detail above, the controller may represent computing infrastructure for the federated learning system as a tree structure. In various embodiments, one or more of the nodes in the tree structure represent different geographic locations in which the computing infrastructure for the federated learning system is located. In some embodiments, the controller may do so by representing at least a portion of the computing infrastructure associated with a particular organization as a singular node in the tree structure.

At step 915, as detailed above, the controller may form associations between datasets available to the federated learning system and nodes in the tree structure. In some embodiments, the associations restrict where the datasets available to the federated learning system may be used for model training. In one embodiment, the datasets available in the federated learning system include at least one public dataset whose association is with a root node of the tree structure. In addition, in some embodiments, the controller may also assign unique identifiers to the datasets available in the federated learning system.

At step 920, the controller may receive one or more instructions to perform model training in the federated learning system with datasets specified using their associations, is as described in greater detail above. In some embodiments, a particular instruction in the one or more instructions to perform the model training indicates that model training results from two or more of the datasets should be grouped. In one embodiment, the particular instruction specifies a location path in the tree structure.

At step 925, as detailed above, the controller may the federated learning system to perform the model training using the datasets specified by the one or more instructions using the tree structure, in response to the one or more instructions. In some embodiments, the controller may do so by configuring a particular device in the computing infrastructure to aggregate the model training results from those two or more of the datasets to be grouped. In various embodiments, the model training in the federated learning system using the datasets specified by the one or more instructions.

It should be noted that while certain steps within procedure 900 may be optional as described above, the steps shown in FIG. 9 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, allow for the simplified configuration of workloads in a federated learning system, such as model training tasks. By representing the computing infrastructure of the federated learning system as a tree structure, and forming associations between the available datasets and that tree structure, aggregation tasks can be configured in a simplified manner. In addition, these associations also allow for restrictions to be placed on the datasets in terms of where and how they may be used by the federated learning system.

While there have been shown and described illustrative embodiments that provide for reconciling computing infrastructure and data in federated learning, it is to be understood that various other adaptations and modifications may be made within the spirit and scope of the embodiments herein. For example, while certain embodiments are is described herein with respect to machine learning workloads directed towards model training, the techniques herein are not limited as such and may be used for other types of machine learning tasks, such as making inferences or predictions, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

1. A method comprising:
representing, by a controller for a federated learning system, computing infrastructure for the federated learning system as a tree structure;
forming, by the controller, associations between datasets available to the federated learning system and nodes in the tree structure;
receiving, at the controller, one or more instructions to perform model training in the federated learning system with datasets specified using their associations; and
configuring, by the controller and in response to the one or more instructions, the federated learning system to perform the model training using the datasets specified by the one or more instructions using the tree structure.

2. The method as in claim 1, wherein one or more of the nodes in the tree structure represent different geographic locations in which the computing infrastructure for the federated learning system is located.

3. The method as in claim 1, wherein the associations restrict where the datasets available to the federated learning system may be used for model training.

4. The method as in claim 1, wherein a particular instruction in the one or more instructions to perform the model training indicates that model training results from two or more of the datasets should be grouped.

5. The method as in claim 4, wherein configuring the federated learning system to perform the model training comprises:
configuring a particular device in the computing infrastructure to aggregate the model training results from those two or more of the datasets.

6. The method as in claim 4, wherein the particular instruction specifies a location path in the tree structure.

7. The method as in claim 1, further comprising:
initiating, by the controller, the model training in the federated learning system using the datasets specified by the one or more instructions.

8. The method as in claim 1, wherein representing the computing infrastructure for the federated learning system as a tree structure comprises:
representing at least a portion of the computing infrastructure associated with a particular organization as a singular node in the tree structure.

9. The method as in claim 1, wherein the datasets available in the federated learning system include at least one public dataset whose association is with a root node of the tree structure.

10. The method as in claim 1, further comprising:
assigning, by the controller, unique identifiers to the datasets available in the federated learning system.

11. An apparatus, comprising:
one or more network interfaces;
a processor coupled to the one or more network interfaces and configured to execute one or more processes; and
a memory configured to store a process that is executable by the processor, the process when executed configured to:
represent computing infrastructure for a federated learning system as a tree structure;
form associations between datasets available to the federated learning system and nodes in the tree structure;
receive one or more instructions to perform model training in the federated learning system with datasets specified using their associations; and
configure, in response to the one or more instructions, the federated learning system to perform the model training using the datasets specified by the one or more instructions using the tree structure.

12. The apparatus as in claim 11, wherein one or more of the nodes in the tree structure represent different geographic locations in which the computing infrastructure for the federated learning system is located.

13. The apparatus as in claim 11, wherein the associations restrict where the datasets available to the federated learning system may be used for model training.

14. The apparatus as in claim 11, wherein a particular instruction in the one or more instructions to perform the model training indicates that model training results from two or more of the datasets should be grouped.

15. The apparatus as in claim 14, wherein the apparatus configures the federated learning system to perform the model training by:
configuring a particular device in the computing infrastructure to aggregate the model training results from those two or more of the datasets.

16. The apparatus as in claim 14, wherein the particular instruction specifies a location path in the tree structure.

17. The apparatus as in claim 11, wherein the process when executed is further configured to:
initiate the model training in the federated learning system using the datasets specified by the one or more instructions.

18. The apparatus as in claim 11, wherein the apparatus represents the computing infrastructure for the federated learning system as a tree structure by:
representing at least a portion of the computing infrastructure associated with a particular organization as a singular node in the tree structure.

19. The apparatus as in claim 11, wherein the datasets available in the federated learning system include at least one public dataset whose association is with a root node of the tree structure.

20. A tangible, non-transitory, computer-readable medium storing program instructions that cause a controller for a federated learning system to execute a process comprising:
representing, by the controller, computing infrastructure for the federated learning system as a tree structure;
forming, by the controller, associations between datasets available to the federated learning system and nodes in the tree structure;
receiving, at the controller, one or more instructions to perform model training in the federated learning system with datasets specified using their associations; and
configuring, by the controller and in response to the one or more instructions, the federated learning system to perform the model training using the datasets specified by the one or more instructions using the tree structure.
